(19) United States
(12) Patent Application Publication
(10) Pub. No.: US 2026/0192729 A1
(43) Pub. Date: Jul. 9, 2026

(54) Screw Motor Actuated Vehicle Box Extension System

(71) Applicant: Xinfang Zhang, Shanxi (CN)

(72) Inventor: Xinfang Zhang, Shanxi (CN)

(21) Appl. No.: 19/009,240

(22) Filed: Jan. 3, 2025

(51) Int. Cl. B60P 3/34; F16H 25/20; F16H 25/24

(52) U.S. Cl. CPC B60P 3/34; F16H 25/24; F16H 2025/2031

(57) ABSTRACT

This application involves a screw motor actuated vehicle box extension system, including a slide-out box, load-bearing plate, load-bearing box, support frame, screw motor, guide rail one, guide rail two, and four slide blocks. The slide-out box is set at the opening of the vehicle body, with corresponding structurally identical load-bearing boxes positioned below the relative side walls, moving synchronously. The load-bearing plate is fixed on the load-bearing box, and guide rails one and two are arranged parallelly up and down through the load-bearing plate and fixed on the load-bearing box. Slide blocks one, two, three, and four are fixed on the support frame, and the bottom of the load-bearing box has a long slot, allowing it to slide back and forth along the lower end of the support frame. This application can achieve the extension and retraction of the vehicle box, increasing the usable space within the vehicle.

### TECHNICAL FIELD

This invention pertains to the field of vehicle interior space expansion technology, particularly a screw motor actuated vehicle box extension system.

### BACKGROUND OF THE INVENTION

Modern vehicles and RVs often employ slide-out boxes to increase internal living space. During travel, the outer wall of the extended box aligns with the exterior of the vehicle or trailer. When stationary, the box slides out from an opening in the vehicle, thereby expanding the usable interior space.

However, existing technologies, such as CN202111541306.4 which discloses an RV expansion mechanism, have issues with large spatial occupation, inconvenient installation, and unstable operation due to non-integrated settings of the extension mechanisms on the underside and sides of the vehicle body.

US202117408020A describes an extension device located on the sides of the slide-out box, which, because of its complex structure and high height of the telescopic drive device, occupies considerable space, is difficult to maintain, and increases usage costs.

Therefore, inventors believe that the extension mechanisms for vehicle boxes are relatively bulky, complicated to install, and costly. Thus, they identify the problem of these mechanisms occupying too much space within the vehicle.

### SUMMARY OF THE INVENTION

To address the issue of the extension mechanism occupying excessive space, this invention provides a screw motor actuated vehicle slide-out system that can increase the useable space within a vehicle, enhance spatial efficiency, and integrate the entire extension mechanism inside a support frame baseplate. This design avoids the need to disassemble the lower chassis of the vehicle, making installation and removal convenient. It only requires fixing the support frame baseplate onto the vehicle body to set the entire slide-out box at the vehicle's opening.

### DETAILED DESCRIPTION OF THE PREFERRED EMBODIMENTS

To achieve this objective, the invention adopts the following technical solution:

A screw motor actuated vehicle box extension system includes a slide-out box, load-bearing plate, support frame, screw motor, guide rail one, guide rail two, slide block one, slide block two, slide block three, slide block four, and load-bearing box. The slide-out box is set at the opening of the vehicle body, with corresponding load-bearing boxes positioned below the relative side walls of the slide-out box. Two load-bearing boxes have identical internal structures, are correspondingly placed, and move synchronously. The load-bearing plate is fixed on the load-bearing box, while the screw motor is mounted on the support frame, with both ends secured to the load-bearing plate. Guide rails one and two are arranged parallelly up and down through the load-bearing plate and fixed on the load-bearing box. Slide blocks one, three connect slidingly with guide rail one, whereas slide blocks two, four connect slidingly with guide rail two. These slide blocks are fixed on the support frame. The screw motor, guide rails one and two, slide blocks one to four, load-bearing plate, and part of the support frame (excluding the baseplate) are integrated inside the load-bearing box. The bottom of the load-bearing box has a long slot, allowing it to slide back and forth along the lower end of the support frame.

By adopting the above technical solution, the screw motor can drive the load-bearing box to slide back and forth, achieving the extension and retraction of the slide-out box. Integrating the screw motor, guide rails, slide blocks, load-bearing plate, and part of the support frame into the load-bearing box isolates them from external influences, facilitates installation and removal, maintains an aesthetically pleasing appearance, and increases the internal useable space of the vehicle. The long slot on the bottom of the load-bearing box allows it to slide in and out from the lower end of the support frame, supporting the entire slide-out box without needing to dismantle the vehicle chassis. By simply fixing the support frame's baseplate to the vehicle body, the whole slide-out box can be suspended at the vehicle's opening, transferring the weight of the slide-out box to the vehicle body via the support frame.

Guide rail one and guide rial two keep a cantilevered setting when the slide-out box is extending or retracting through fixed slide blocks one, two, three, and four.

The cantilevered setting ensures that the slide-out box can protrude further, increasing interior space without requiring additional support.

Slide blocks one and two are aligned vertically, as are slide blocks three and four, with slide blocks one parallel to three and two parallel to four.

This ensures balanced force distribution during the reciprocating motion of the guide rails, ensuring smooth operation and minimal friction.

Load-bearing plate has fixing brackets one and two at both ends, with the screw motor fixed to the load-bearing plate via these brackets.

This supports the threaded screw and ensures that the center axis of the screw remains straight. Additionally, the motor drives the rotation of the threaded screw, thus moving the load-bearing plate.

Support frame consists of upper board, lower board, baseplate, motor bracket, and reinforcement plate. The screw motor passes through motor bracket and reinforcement plate, with the motor fixed to motor bracket.

This keeps the motor fixed and allows the support frame to bear the weight of the screw motor.

Slide blocks one and three are fixed on the lower board, while slide blocks two and four are fixed on the upper board.

This keeps the slide blocks stationary while the guide rails move through them.

Baseplate is fixed to the vehicle body.

This transfers the weight borne by the support frame to the vehicle body.

The load-bearing plate, load-bearing box, and screw motor are parallel along their lengths.

This ensures balanced force distribution and smooth movement when the screw motor moves the load-bearing plate, leading to less friction.

The load-bearing box has a detachable maintenance panel near the interior side of the box.

This facilitates installation and allows for repairs inside the load-bearing box by removing the maintenance panel, reducing maintenance costs.

In summary, this application includes at least one of the following beneficial technical effects:
1. Integrating the screw motor, guide rails, slide blocks, load-bearing plate, and part of the support frame (excluding the baseplate) into the load-bearing box isolates them from external influences, makes installation and removal convenient, maintains an aesthetic appearance, and increases the internal usable space of the vehicle.
2. Since the entire extension mechanism inside the load-bearing box is integrated onto the support frame baseplate, there is no need to dismantle the lower chassis of the vehicle body. Installation and removal are simple; fixing the support frame's baseplate to the vehicle body sets the entire slide-out box at the vehicle's opening, with the support frame transferring the weight of the slide-out box to the vehicle body.
3. The detachable maintenance panel on the load-bearing box allows for repairs inside the load-bearing box by removing the panel, reducing maintenance costs.

### BRIEF DESCRIPTION OF THE DRAWINGS

To more clearly explain the technical solutions of this invention, the drawings used in the description are briefly introduced below. Clearly, the drawings described herein are merely some embodiments of the invention. Without creative effort, those skilled in the art can obtain other drawings based on these drawings.

FIG. 1 shows the oblique view of the slide-out box sliding out from the opening of the vehicle body in a specific implementation.

FIG. 2 shows the oblique view of the slide-out box completely retracted into the opening of the vehicle body in a specific implementation.

FIG. 3 shows the front cross-sectional view of the slide-out box in a specific implementation.

FIG. 4 shows the schematic diagram of the extension mechanism in a specific implementation.

FIG. 5 shows the half cross-sectional view inside the load-bearing box when the slide-out box is fully extended in a specific implementation.

FIG. 6 shows the half cross-sectional view inside the load-bearing box when the slide-out box is fully retracted in a specific implementation.

FIG. 7 includes 7A as the oblique view of the slide-out box being extended, 7B as the side view of the slide-out box being extended, and 7C as the cross-sectional view of the load-bearing box after the slide-out box is extended.

FIG. 8 includes 8A as the oblique view of the slide-out box being retracted, 8B as the side view of the slide-out box being retracted, and 8C as the cross-sectional view of the load-bearing box after the slide-out box is retracted.

### BRIEF DESCRIPTION OF THE FIGURES

Follow are the reference numbers appear in the drawings:
1. Slide-out box
2. Load-bearing box, 203. Maintenance panel
3. Support frame, 3a. Upper board, 3b. Lower board, 3c. Baseplate
4. Screw motor, 4a. Fixed bracket one, 4b. Fixed bracket two
5a. Motor bracket, 5b. Reinforcement plate
6a. Guide rail one, 6b. Guide rail two
8a. Slide block one, 8b. Slide block two, 8c. Slide block three, 8d. Slide block four
9. Long slot
25. Vehicle body

### DETAILED DESCRIPTION OF THE INVENTION

To make the objectives, characteristics, and advantages of this invention clearer and easier to understand, the technical solutions in this patent will be described clearly and completely in conjunction with the accompanying drawings in the specific implementations below. Obviously, the implementations described below are only part of the implementations of this invention and not all of them. Based on the implementations in this patent, all other implementations obtained by those skilled in the art without creative effort fall within the scope of protection of this patent.

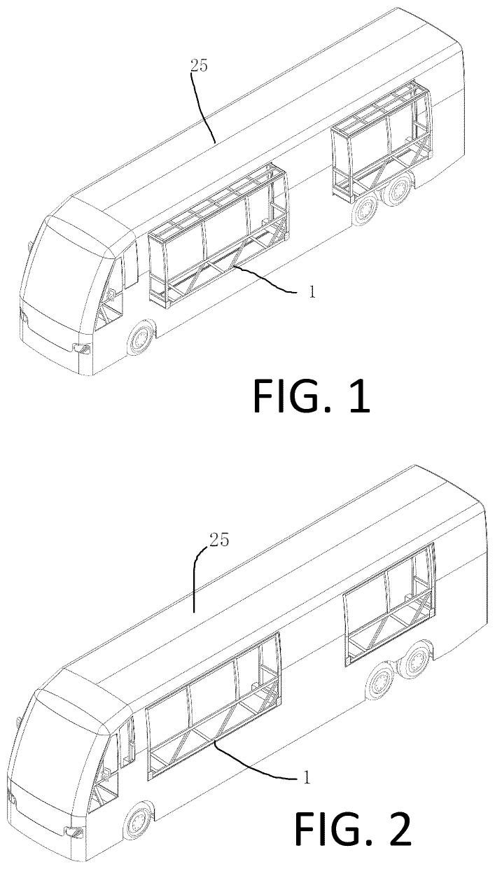

Referring to FIGS. 1 and 2, the slide-out box 1 is set at the opening of the vehicle body 25. When the vehicle is stationary, the slide-out box 1 slides out completely from the opening of the vehicle body 25, increasing the internal usable space of the vehicle. After retraction, the slide-out box 1 aligns with the exterior of the vehicle body 25, maintaining overall aesthetics.

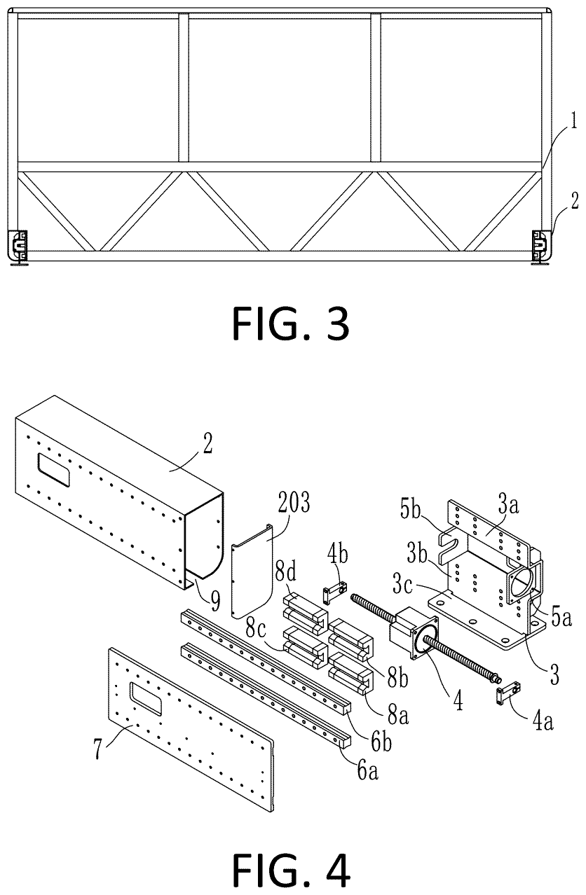

Referring to FIGS. 3 and 4, a screw motor actuated vehicle box extension system includes an slide-out box 1, load-bearing plate 7, support frame 3, screw motor 4, guide rail one 6a, guide rail two 6b, slide block one 8a, slide block two 8b, slide block three 8c, slide block four 8d, and load-bearing box 2. The slide-out box 1 is made of aluminum alloy or other structurally lightweight materials, with corresponding load-bearing boxes 2 positioned below the relative side walls. Two load-bearing boxes 2 have identical internal structures, are correspondingly placed, and move synchronously, bearing the weight of the slide-out box 1. The screw motor 4, guide rails one 6a and two 6b, slide blocks one 8a to four 8d, load-bearing plate 7, and part of the support frame 3 excluding the baseplate are integrated inside the load-bearing box 2, saving space and facilitating rapid installation and removal.

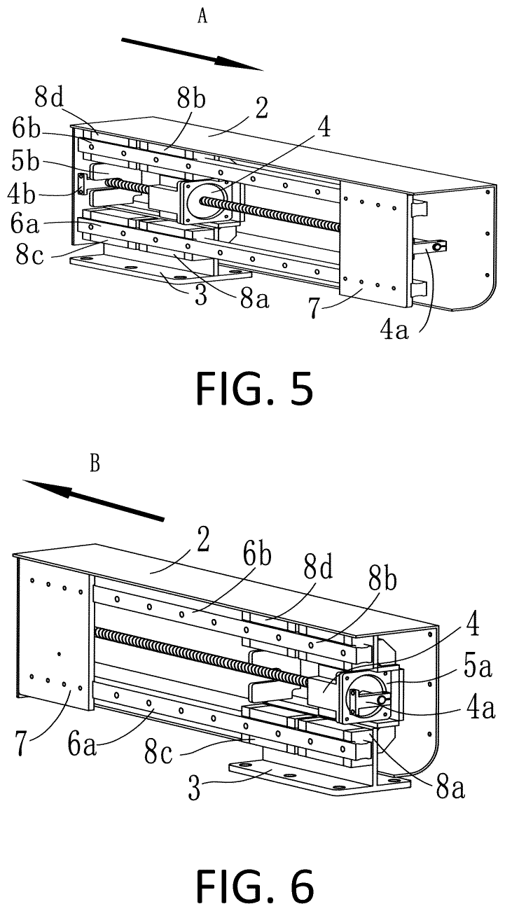

Referring to FIGS. 5 and 6, the load-bearing plate 7 is fixed on the load-bearing box 2, with fixed brackets one 4a and two 4b at both ends. The support frame 3 includes upper board 3a, lower board 3b, baseplate 3c, motor bracket 5a, and reinforcement plate 5b. The screw motor 4 passes through motor bracket 5a and reinforcement plate 5b, with the motor fixed to motor bracket 5a and both ends fixed to the load-bearing plate 7 via fixed brackets one 4a and two 4b. Guide rails one 6a and two 6b are arranged parallelly up and down through the load-bearing plate 7 and fixed on the load-bearing box 2. Slide blocks one 8a, three 8c connect slidingly with guide rail one 6a, and slide blocks two 8b, four 8d connect slidingly with guide rail two 6b. Slide blocks one 8a and three 8c are fixed on the lower board 3b, and slide blocks two 8b and four 8d are fixed on the upper board 3a. Slide blocks one 8a and two 8b are vertically aligned, as are slide blocks three 8c and four 8d, with slide blocks one 8a parallel to three 8c and slide blocks two 8b parallel to four 8d. Guide rail one 6a connects through slide blocks one 8a and three 8c, and guide rail two 6b connects through slide blocks two 8b and four 8d, keeping the slide-out box 1 in a cantilevered setting when extending and retracting. The load-bearing box 2 has a detachable maintenance panel 203 near the interior side of the box, allowing for installation and maintenance inside the load-bearing box by removing the maintenance panel. The bottom of the load-bearing box 2 has a long slot 9, enabling it to slide back and forth along the sides of the support frame 3.

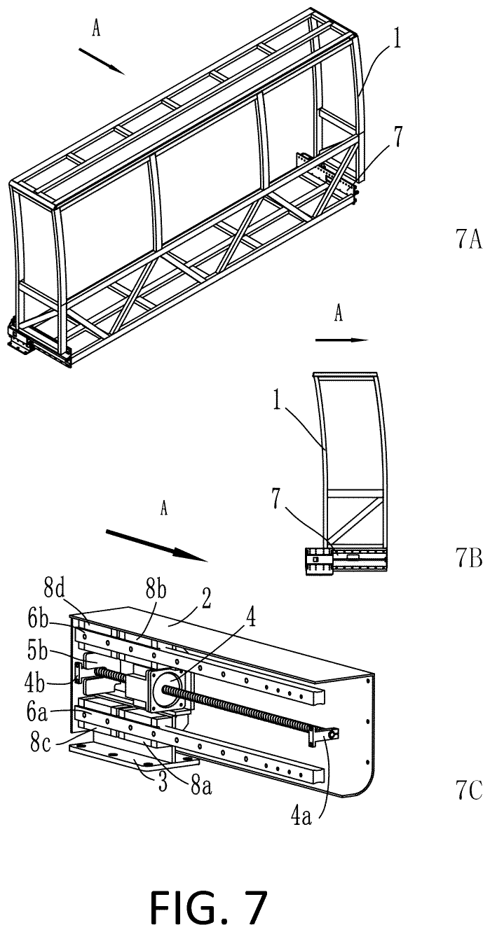

Referring to FIG. 7, when the slide-out box is extended, the motor on the screw motor drives the threaded screw to rotate, thereby moving the load-bearing box 2 and load-bearing plate 7 together through guide rails one 6a and two 6b. When the slide-out box slides to a predetermined length, the extension process ends. The support frame 3 remains stationary, and after the slide-out box 1 slides out, the load-bearing box 2 transfers the weight of the slide-out box 1 to the load-bearing plate 7, which then transfers the weight through guide rails one 6a and two 6b to slide blocks one 8a, two 8b, three 8c, and four 8d, finally transferring the weight to the support frame 3 and then to the vehicle body 25.

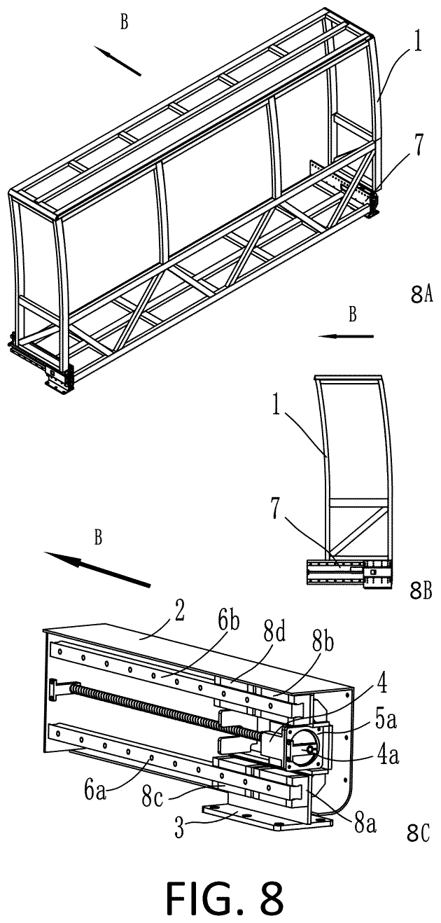

Referring to FIG. 8, when the slide-out box is retracted, the motor on the screw motor reverses the rotation of the threaded screw, thereby moving the load-bearing box 2 and load-bearing plate 7 together inward through guide rails one 6a and two 6b. When the slide-out box 1 aligns with the exterior of the vehicle body 25, the retraction process ends.

The above explanation of the disclosed implementations enables professionals in the field to implement or use this invention. Various modifications to these implementations will be obvious to professionals in the field, and the general principles defined herein can be implemented in other implementations without departing from the spirit or scope of this invention. Therefore, this invention should not be limited to the implementations shown herein but should conform to the broadest scope consistent with the principles and novel features disclosed herein.

1. A screw motor actuated vehicle box extension system, comprising a slide-out box, load-bearing plate, load-bearing box, support frame, screw motor, guide rail one, guide rail two, slide block one, slide block two, slide block three, and slide block four. The slide-out box is set at the opening of the vehicle body, with corresponding load-bearing boxes positioned below the relative side walls. Two load-bearing boxes have identical internal structures, are correspondingly placed, and move synchronously. The load-bearing plate is fixed on the load-bearing box, and guide rails one and two are arranged parallelly up and down through the load-bearing plate and fixed on the load-bearing box. Slide blocks one, three connect slidingly with guide rail one, and slide blocks two, four connect slidingly with guide rail two. These slide blocks are fixed on the support frame. The screw motor, guide rails one and two, slide blocks one to four, load-bearing plate, and part of the support frame (excluding the baseplate) are integrated inside the load-bearing box. The bottom of the load-bearing box has a long slot, allowing it to slide back and forth along the lower end of the support frame.

2. According to claim 1, the characteristic feature of the screw motor actuated vehicle box extension system is that guide rails one and two maintain a cantilevered setting when the slide-out box is extending or retracting through fixed slide blocks one, two, three, and four.

3. According to claim 2, the characteristic feature of the screw motor actuated vehicle box extension system is that slide blocks one and two are vertically aligned, as are slide blocks three and four, with slide blocks one parallel to three and slide blocks two parallel to four.

4. According to claim 3, the characteristic feature of the screw motor actuated vehicle box extension system is that the load-bearing plate has fixed brackets one and two at both ends, with the screw motor fixed to the load-bearing plate via these brackets.

5. According to claim 4, the characteristic feature of the screw motor actuated vehicle box extension system is that the support frame includes upper board, lower board, baseplate, motor bracket, and reinforcement plate. The screw motor passes through motor bracket and reinforcement plate, with the motor fixed to motor bracket.

6. According to claim 5, the characteristic feature of the screw motor actuated vehicle box extension system is that slide blocks one and three are fixed on the lower board, and slide blocks two and four are fixed on the upper board.

7. According to claim 6, the characteristic feature of the screw motor actuated vehicle box extension system is that the baseplate is fixed to the vehicle body.

8. According to claim 7, the characteristic feature of the screw motor actuated vehicle box extension system is that the load-bearing plate, load-bearing box, and screw motor are parallel along their lengths.

9. According to claim 8, the characteristic feature of the screw motor actuated vehicle box extension system is that the load-bearing box has a detachable maintenance panel near the interior side of the box.
